(19) United States
(12) Patent Application Publication
(10) Pub. No.: US 2007/0188648 A1
(43) Pub. Date: Aug. 16, 2007

(54) Switch devices of micro distance micrography for digital cameras

(75) Inventor: Chihyi Yang, Taipei (TW)

Correspondence Address: BACON & THOMAS, PLLC, 625 SLATERS LANE, FOURTH FLOOR, ALEXANDRIA, VA, 22314, US

(73) Assignee: LUMOS TECHNOLOGY CO., LTD, Taipei (TW)

(21) Appl. No.: 11/350,896

(22) Filed: Feb. 10, 2006

(51) Int. Cl. H04N 5/225; G02B 13/16

(52) U.S. Cl. 348/335

(57) ABSTRACT

The innovation is a switch device of micro distance micrography, applying to digital cameras. The main body has a shell-shaped structure with an inner space and a hollow part, which can be penetrated by a lens of digital camera. On the other hand, the shell-shaped structure is jointed and fixed to the main body of the digital camera. The mirror tube ring is a hollow structure and fixed to the main body, and surrounds the hollow part of the main body. The mirror slice frame is jointed to the mirror tube ring, and there is a small hole for mirror slices in the center of mirror slice frame. The mirror slice is mounted to the mirror slice hole. Light source component established between the long mirror tube and mirror slice frame are at least above one. Moreover, the lights produced by certain light source components run through the long mirror tube till the exterior.

### BACKGROUND OF THE INVENTION

(a) Field of the Invention

The innovation is about the accessory of digital camera, especially about a switch device of micro distance micrography applied to digital cameras.

(b) Description of Related Art

Usually, the structure of traditional switch device of micro distance micrography applied to digital cameras is one mirror tube, which includes at least above one mirror slice inside, and is screwed to digital cameras when using. Due to the traditional structure factor, the effect of micrography through the traditional device is limited.

In view of the shortcoming of the traditional switch device of micro distance micrography, the structure of new innovation is ameliorated to a totally different one to make the effect of micrography to be greatly promoted

### SUMMARY OF THE INVENTION

The purpose of the new innovation is to offer a switch device of micro distance micrography suitable for each kind of digital cameras. Through the new innovation, the effect of micro distance micrography on cameras can become more outstanding.

In order to reach the outstanding effect, the innovation offers a switch device of micro distance micrography applied to digital cameras. The main body has a shell-shaped structure with an inner space and a hollow part, which can be penetrated by a lens of digital camera. On the other hand, the shell-shaped structure is jointed and fixed to the main body of digital camera. The mirror ring is a hollow ring structure and jointed to the main body, and surrounds the hollow part of the main body. The mirror slice frame is jointed to the mirror tube ring, and there is a small hole in the center of mirror slice frame. The mirror slice is mounted to the mirror slice hole of the mirror slice frame. The light source components installed between the long mirror tube and mirror slice frame are at least above one. Moreover, the lights produced by certain light source components run through the long mirror tube till the exterior. The long mirror tube is mounted to the mirror slice frame.

### BRIEF DESCRIPTION OF THE DRAWINGS

FIG. 1 is a exploded view of the innovation when applied to digital cameras.

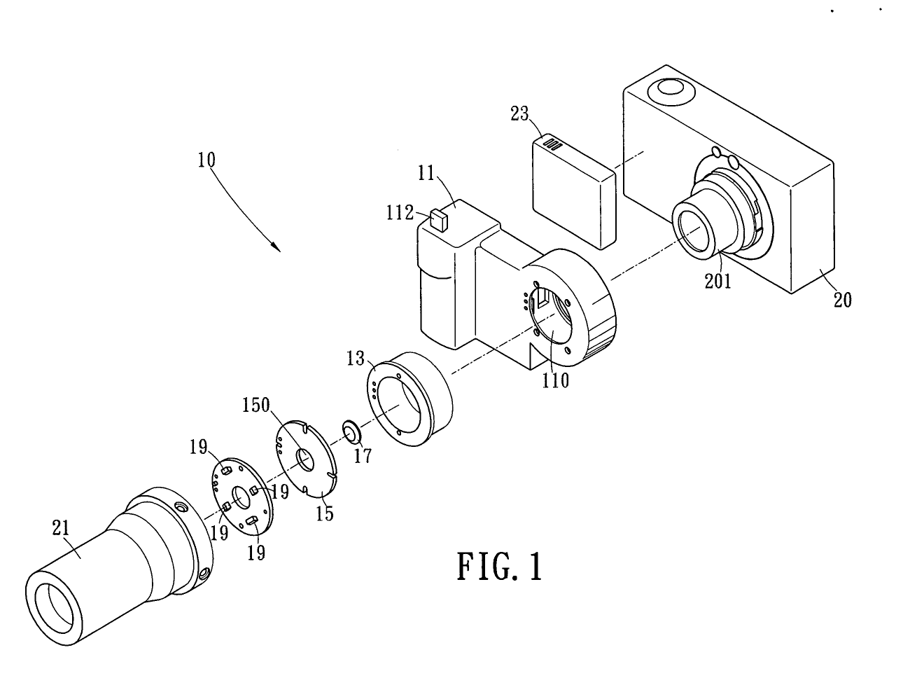

### DETAILED DESCRIPTION OF PREFERRED EMBODIMENTS

The first graph is the three-dimensional exploded view of the new innovation—micro distance micrography—on camera The innovation [10] is a switch device of micro distance micrography, which matches the use of digital camera [20]. When using the innovation, users need to joint the switch device of micro distance micrography[10] to the digital camera[20], and then users can shoot the object at a very close distance. On the other hand, as the innovation—switch device of micro distance micrography [10]—has the zoom function, users can shoot a object in a micro effect. The specification of each component is described as below:

The main body [11] is a shell-shaped structure and jointed to the digital camera [20]. Also, the shell-shaped structure has an inner space and a hollow part [110], which makes the lens [201] capable of penetrating the digital camera [20]. The material choice of the shell-shaped structure can be a lightproof material, for example, non-transparent plastic materials, or metal.

The mirror tube ring [13] is a hollow ring structure and jointed to the main body [11] The hollow area of the mirror tube ring [13] surrounds the hollow part [110] of the main body [11]. When the length of the lens [201] is longer than the thickness of the digital camera[20], the lens [201], penetrating the hollow part [110] can penetrate the minor tube ring[13], too, at the same time. The material choice for the mirror tube ring can be a lightproof material, for example, non-transparent plastic materials, or metal.

The mirror slice frame [15] is jointed to the mirror tube ring [13], and there is a mirror slice hole in the center of the mirror slice frame [15]. The mirror slice [17] is mounted to the mirror slice hole [150] of the minor slice frame [15] The material choice for the mirror slice frame can be a lightproof material, for example, non-transparent plastic materials, or metal.

The light source components [19] installed between the long mirror tube [21] and mirror tube frame[15] are at least above one. These light source components [19] are used to produce light sources, which penetrate the long mirror tube [21] until the exterior. The light source components [19] are capable of adopting LED and welded to a thin board, for example, a printed circuit board. Or, these light source components [19] can be installed over the mirror slice frame [15]

The long mirror tube [21] is jointed to the mirror slice [15]. The long mirror tube [21] is used to approach the shot objects, and the optics path of the composite images of the shot objects goes through the long mirror tube [21], the mirror slice [17], and then the lens[201]

Moreover, the switch device of micro distance micrography [10] includes a battery [23]. The battery [23] is electricity and connected to the light source components [19]. Besides, it provides electric power to the light source components [19]. The battery can be set between the digital camera [20] and main body [11].

In addition, the switch device of micro distance micrography [10] further includes a switch [112]. The switch [112] is connected to the battery [112] and set to the main body. The switch [112] is for the on-off control of the battery [23]

Besides, the switch device of micro distance micrography [10] further includes a printed circuit board, undemonstrated, which is set in the inner space of the main body [11], and can be welded with some circuit components as the control circuit of the switch device of micro distance micrography [10]

The switch device of micro distance micrography [10] can promote the value added of digital cameras and make digital cameras become a magnifier-like device, and this is the advantages of the device.

Although there is a clear exposition for the innovation above, the exposition should not be a limitation of the innovation. Of course, any person who is familiar with the skill can make any change or embroidery, but if within the scope and spirit of the innovation, these changes and embroideries will still be within the scope of following patent application of the innovation.

1. A switch device of micro distance micrography applied to digital cameras, comprising: (a) a main body, which is a shell-shaped structure with an inner space and hollow part, which make the lens capable of penetrating the digital camera, and is jointed to the body of digital camera; (b) a mirror tube ring, which is a hollow ring structure and jointed to the main body, surrounding the hollow part; (c) a mirror slice frame, which is jointed to the mirror tube ring, and has a mirror slice hole in the center area; (d) a mirror slice, mounted to the mirror slice hole of the mirror slice frame; (e) light source components installed between the long mirror tube and mirror slice frame, at least above one, and the lights produced by the light source components going through the long mirror tube mounted to the mirror slice frame until the exterior.

2. The switch device of micro distance micrography as in claim 1, wherein said the light source components are LED.

3. The switch device of micro distance micrography as in claim 1, further including a battery, jointed to the light source components.

4. The switch device of micro distance micrography as in claim 3, further including a switch, jointed to the battery and set to the main body.

5. The switch device of micro distance micrography as claim 3, wherein said the battery is installed between the digital camera and main body.

6. The switch device of micro distance micrography as in claim 1, wherein said the inner space of the main body is for the placement of printed circuit board.

7. The switch device of micro distance micrography as in claim 1, wherein said the shell-shaped structure of the main body can be jointed and fixed to a handset with a photography function or to the body of PDA with a photography function.
